(19) United States
(12) Patent Application Publication
(10) Pub. No.: US 2010/0099006 A1
(43) Pub. Date: Apr. 22, 2010

(54) GALVANIC ELEMENT COMPRISING A MELAMINE/FORMALDEHYDE FOAMED PLASTIC

(75) Inventors: Hans-Jürgen Quadbeck-Seeger, Bad Durkheim (DE); Armin Alteheld, Bad Kreuznach (DE); Klaus Hahn, Kirchheim (DE); Christof Möck, Mannheim (DE); Bernhard Vath, Mannheim (DE)

Correspondence Address: CONNOLLY BOVE LODGE & HUTZ, LLP, P O BOX 2207, WILMINGTON, DE, 19899, US

(73) Assignee: BASF SE, LUDWIGSHAFEN (DE)

(21) Appl. No.: 12/526,412

(22) PCT Filed: Feb. 5, 2008
(86) PCT No.: PCT/EP08/51391

§ 371 Date: Aug. 7, 2009

(30) Foreign Application Priority Data
Feb. 8, 2007 (EP) 07101963.2
Mar. 5, 2007 (EP) 07103507.5

(51) Int. Cl. H01M 2/02; H01M 6/18; H01M 4/82

(52) U.S. Cl. 429/34; 429/306; 29/623.2

(57) ABSTRACT

An electrochemical element which comprises an open-cell foam based on a melamine/formaldehyde foam, the cell pores being completely or partly filled with a flowable electrolyte and a process for the production of a battery, accumulator or fuel cell.

The invention relates to an electrochemical element which comprises an open-cell foam based on a melamine/formaldehyde foam, the cell pores being completely or partly filled with a flowable electrolyte, and the process for the production of a battery, accumulator or fuel cell.

Open-cell foams based on a melamine/formaldehyde condensate are known for various heat- and sound-insulating applications in buildings and vehicles and as insulating and impact-absorbing packaging material. The open-cell structure permits the take-up and storage of suitable cleaning agents, abrasives and polishes when used as a cleaning, abrasive and polishing sponge (WO 01/94436).

EP-A 1 498 680 describes a thermal storage unit which comprises an open-cell foam based on a melamine/formaldehyde condensate whose cell pores are completely or partly filled with a flowable heat-transfer medium, and the production and use thereof as an accumulator for maintaining cold and heat.

A liquid store comprising an open-cell foam based on a melamine/formaldehyde condensate having a covering of metal or plastic and the use as a fuel tank, oil tank, tank container for tanker vehicles, tanker trailer or tanker ships, in particular for the storage or transport of hazardous liquid substances, environmentally hazardous substances or cryogenic liquids, are disclosed in WO 2007/003608.

Conventional batteries can easily leak when the outer skin is damaged. Dry batteries generally comprise a thickener, e.g. starch. This thickener increases the viscosity of the electrolyte, with the result that as a rule the ionic mobility is reduced. In addition, electrolytes and thickeners must be tailored to one another in order to avoid incompatibilities (e.g. precipitation of salts). Thickeners require some time for taking up the liquid or, for example, have to be dissolved in the liquid phase by mechanical stirring.

It was an object of the present invention to remedy the abovementioned disadvantages and to provide an electrochemical element which is filled with a flowable electrolyte so that it is substantially leak-proof.

Accordingly, the electrochemical element described above was found.

Preferably used open-cell foams are resilient foams based on a melamine/formaldehyde condensate having a specific density of from 5 to 100 g/l, in particular from 8 to 20 g/l. The cell count is usually in the range of from 50 to 300 cells/25 mm. The tensile strength is preferably in the range of from 100 to 150 kPa and the elongation at break in the range of from 8 to 20%.

According to EP-A 071 672 or EP-A 037 470, a highly concentrated, blowing agent-containing solution or dispersion of a melamine-formaldehyde precondensate can be foamed using hot air or steam or by microwave irradiation and cured for the production. Such foams are commercially available under the name Basotect® from BASF Aktiengesellschaft.

The molar melamine/formaldehyde ratio is in general in the range of from 1:1 to 1:5. For the production of particularly low-formaldehyde foams, the molar ratio is chosen to be in the range of from 1:1.3 to 1:1.8 and a precondensate free of sulfite groups and as described, for example, in WO 01/94436 is used.

In order to improve the performance characteristics, the foams can then be annealed and pressed. The foams can be cut to the desired shape and thickness and can be laminated on one or both sides with outer layers. In the case of covering with a plastic sheet, the outer layer is as a rule not necessary.

For high-temperature applications, the open-cell foam based on a melamine/formaldehyde condensate can be partly or completely carbonized at temperatures above 200° C., preferably at temperatures in the range of from 200 to 500° C. Depending on the degree of carbonization, the foam becomes brittle but the struts of the open-cell foam structure are substantially retained, and a partly carbonized material which is stable at high temperatures and is suitable in particular for use in fuel cells or as a catalyst support is thus obtained.

The carbonization of the foam can be improved by impregnation with carbonizing substances, for example pitch or carbohydrates.

The electrochemical element can be used, for example, in batteries or fuel cells. The flowable electrolyte is chosen according to the intended use and temperature range. It should be flowable at least in the part-ranges of the temperatures during use or filling, as a rule at room temperature. A preferably used electrolyte is an ionic liquid, for example 1-butyl-3-methylimidazolium acetate, a liquid solution of ions or a salt melt, for example of lithium, sodium, potassium, cesium or zinc halides, nitrates or sulfates, or acids, such as carboxylic acids, hydrochloric acid or sulfuric acid.

Owing to the low density of the foam and the open-cell character, more than 95% by volume, in particular more than 98% per volume, of the electrochemical element filled with the open-cell foam are available for taking up the liquid.

The open-cell foam of the electrochemical element is preferably provided with a covering resistant to the electrolyte. The covering preferably consists of a sheet of metal or plastic, for example polyolefin, such as polyethylene or polypropylene.

The covering may additionally comprise a heat-insulating surrounding layer, for example of polyurethane foam, and/or a liquid barrier layer, such as plastic films. The covering serves for stability and protection of the liquid store. The cross section is as a rule round or oval.

The liquid electrolyte penetrates into the open-cell foam and prevents accidental leakage. The liquid electrolyte therefore remains substantially bound in the pores of the foam, even when the covering is damaged, and leakage is prevented.

Depending on whether a higher storage capacity or mobility of the liquid electrolyte is desired, the capillary forces can be specifically adapted by changing the cell size or the hydrophobicity or hydrophilicity of the open-cell foam. Depending on the chemical type and viscosity of the liquid electrolyte, the surface of the cell framework of the open-cell foam can be completely or partly coated with a water repellant, for example an aqueous emulsion of a silicone ester or fluoroalkyl ester.

Owing to the resilience of the open-cell foam, the latter can be introduced into prefabricated tanks in a simple manner. Smaller containers can also be filled with foam flakes.

Even at low temperatures, for example below −80° C., the foam remains resilient. Damage due to embrittlement does not occur. The electrochemical element according to the invention is therefore also suitable for taking up cryogenic liquids, for example liquid air, nitrogen, hydrogen, noble gasses, such as argon, neon or helium, and hydrocarbons such as propylene or methane.

Particularly preferably, one or more electrochemical elements according to the invention are used in batteries or fuel cells, if appropriate also in combination with conventional electrochemical elements. The electrodes customary for batteries or fuel cells and comprising metals such as copper, iron, zinc or metal alloys and the various carbon modifications, for example graphite, can be used as electrodes. In the case of appropriate conductivity, for example conductive polymers or metals, the covering can simultaneously perform the function of an electrode.

A battery comprising the electrochemical element according to the invention is leak-proof like a dry battery, i.e. can be used in any position. Owing to capillary forces, the open-cell foam has a leakage-prevention effect. No thickener is necessary and the ionic mobility is not impaired at all. A battery or accumulator filled with the open-cell foam can be very easily refilled with liquid but is leak-proof. The liquid is taken up immediately in the foam.

Efficient accumulators used according to the prior art in cell phones or notebooks are frequently based on Li ion batteries. These can decompose explosively or with formation of fire on heating or in the case of short-circuits, which complicates, for example, the introduction of the technology into electric cars or cars with a hybrid drive. By using a foam, the energy is advantageously dissipated even in the case of explosive decomposition and a possible fire occurs only immediately on leakage.

### EXAMPLES

### Example 1 (Daniel Element)

A 1 molar zinc sulfate solution was introduced into a beaker, and a strip of a zinc sheet was dipped into said solution. A 1 molar copper sulfate solution is introduced into a second beaker. A copper sheet is dipped into this vessel. The two metal sheets were connected to a voltage tester by means of cables. No voltage was measured. A cylinder comprising Basotect® is impregnated with a 1 molar potassium nitrate solution. One end of the impregnated foam was dipped into the copper sulfate solution and the other end thereof into the zinc sulfate solution. After the connection of the two vessels via the salt bridge, a voltage of 1.1 V is measured.

### Example 2

A copper tube was filled with Basotect®. The foam was impregnated with a concentrated sodium chloride solution. A galvanized nail was inserted into the center of the foam. The zinc nail and the copper tube are connected via a cable with connected voltage meter. A voltage of 0.8 V was measured. Basotect® served as a spacer, prevents leakage and does not impair the ionic transport.

### Example 3

The procedure was analogous to that of example 2, an ionic liquid (1-butyl-3-methylimidazolium acetate) being used instead of sodium chloride solution. A voltage of 0.8 V was likewise determined. Ionic liquids have a low vapor pressure and the system is therefore very stable.

### Example 4 (Partly Carbonized Basotect®)

A sample of Basotect® was annealed for 10 hours at 200° C. in a drying oven. Thereafter, the material was heated under a nitrogen atmosphere to 300° C. for two hours and then to 400° C. for one hour. The residue obtained has a black discoloration and a weight loss of 30%. Elemental analysis gave the following results:

After 10 h at 200° C.: C=35.2% by weight, H=4.8% by weight, N=10.8% by weight

After partial carbonization: C=44.0% by weight, H=2.1% by weight, N=7.1% by weight

The foam structure was scarcely destroyed by the partial carbonization. The material obtained has poorer mechanical properties but is not completely brittle.

### Example 5

A sample of Basotect® was washed and was combusted with the open flame of a Bunsen burner so that the material was completely carbonized but the foam structure was substantially retained. The combustion residue was about 7% by weight of material used. The residue consisted of an open-cell porous and cohesive structure. The mechanical properties, in particular the resilience, have substantially deteriorated.

The chemical analysis of the elements carbon, nitrogen and hydrogen of the combustion residue shows a decrease in the proportion of hydrogen. The following values are determined: 46.8% by mass of carbon, 36.1% by mass of nitrogen and 2.0% by mass of hydrogen.

The partly carbonized foam structures of examples 4 and 5 show high thermal stability and low formaldehyde emission even at above 250° C. They can be used for taking up salt melts in electrochemical elements.

1.-8. (canceled)

9. An electrochemical element comprising an open-cell foam based on a melamine/formaldehyde condensate, wherein the cell pores are completely or partly filled with a flowable electrolyte and wherein the electrolyte is an ionic liquid, a liquid solution of ions or a salt melt.

10. The electrochemical element according to claim 9, wherein the open-cell foam is provided with a covering stable to the electrolyte.

11. The electrochemical element according to claim 10, wherein the covering consists of a sheet of metal or plastic.

12. The electrochemical element according to claim 9, which comprises a melamine/formaldehyde condensate having a molar melamine/formaldehyde ratio in the range of from 1:1 to 1:5.

13. The electrochemical element according to claim 9, wherein the melamine/formaldehyde condensate has a specific density of from 5 to 100 g/l.

14. The electrochemical element according to claim 12, wherein the open-cell foam was partly or completely carbonized at temperatures in the range of from 200 to 500° C.

15. The electrochemical element according to claim 14, wherein the melamine/formaldehyde condensate has a specific density of from 5 to 100 g/l.

16. The electrochemical element according to claim 15, wherein the open-cell foam was partly or completely carbonized at temperatures in the range of from 200 to 500° C.

17. A battery, accumulator or fuel cell comprising one or more electrochemical elements according to claim 9.

18. A battery, accumulator or fuel cell comprising one or more electrochemical elements according to claim 16.

19. A battery comprising one or more electrochemical elements according to claim 9.

20. An accumulator comprising one or more electrochemical elements according to claim 16.

21. A fuel cell comprising one or more electrochemical elements according to claim 9.

22. A process for the production of a battery or fuel cell according to claim 17, which comprises providing the open-cell foam based on a melamine/formaldehyde condensate with a covering and one or more electrodes and is filled with a flowable electrolyte before being completely sealed.
